(19) United States
(12) Patent Application Publication
(10) Pub. No.: US 2005/0183994 A1
(43) Pub. Date: Aug. 25, 2005

(54) Integrated Shale Shaker and Dryer

(75) Inventors: Gary L. Hensley, Kingwood, TX (US); Lee Hilpert, Livingston, TX (US)

Correspondence Address: TIM COOK, P.O. BOX 10107, LIBERTY, TX, 77575, US

(73) Assignee: HUTCHISON HAYES, L.P., Houston, TX (US)

(21) Appl. No.: 10/906,154

(22) Filed: Feb. 4, 2005

Related U.S. Application Data
(60) Provisional application No. 60/543,583, filed on Feb. 11, 2004.

(51) Int. Cl. B07B 1/46

(52) U.S. Cl. 209/238; 209/311; 209/11

(57) ABSTRACT

An integrated, transportable cuttings treatment system includes a multi-part shale shaker, preferably formed of six screens vibrated by at least one electric vibrator, and preferably four such vibrators. Solids are screen from drilling mud flowing onto the screens, and directed into a trough wherein is located a screw conveyor or augur. A pressure differential is developed across the screens to increase the flow rate of drilling mud through the screens.

### DESCRIPTION

This application claims the benefit of provisional U.S. Patent application Ser. No. 60/543,583 filed Feb. 11, 2004.

### FIELD OF THE INVENTION

The present invention relates generally to the field of shale shakers commonly used in the treatment of drilling mud and, more particularly, to an integrated system including a shale shaker and a dryer to treat the cuttings separated by the shale shaker.

### BACKGROUND OF THE INVENTION

As described in U.S. Pat. No. 5,392,925 to Seyffert, the need for controlling the solids content in drilling mud is well known in the art. Drilling mud, typically a mixture of clay, water, and various additives, is pumped down through the center of a drill string into a well. At the bottom of the drill string, the drilling mud exits through holes or jets in a drill bit. The mud picks up cuttings and other solids from the well and carries them upwardly away from the bit and out of the well in the annulus between the well walls and the drill string.

At the top of the well, the solids-laden mud is introduced to a shale shaker, a device which typically has a series of screens arranged in tiered or flat disposition with respect to each other. The screens catch and remove solids from the mud as the mud passes through them. If drilled solids are not removed from the mud used during the drilling operation, recirculation of the drilled solids can create viscosity and gel problems in the mud, as well as increasing wear in mud pumps and other mechanical equipment used for drilling.

The frame of the vibrating screen is resiliently suspended or mounted upon a support and is caused to vibrate by a vibrating mechanism, e.g. an unbalanced weight on a rotating shaft connected to the frame. Each screen may be vibrated by vibratory equipment to create a flow of trapped solids in either direction on top surfaces of the screens for removal and disposal of solids. The fineness or coarseness of the mesh of a screen may vary depending upon mud flow rate and the size of the solids to be removed.

Solids are typically taken from the shale shaker by a transport system, such as for example an augur, and the liquid drilling mud is pumped or drained away for further treatment. A major problem with the art just described is that the cuttings laden drilling mud is introduced to the top surfaces of the shale shaker screen and allowed to flow downward through the screen by gravity alone. If a pressure differential were introduced across the screens, then the rate of flow of the drilling mud through te screens would be enhanced.

Another major problem with the art is that the shale shaker itself occupies a rather large area, and area is a precious commodity on offshore drilling rigs. Furthermore, the solids must be transported away from the shale shaker to remove more of the drilling mud from the cuttings, and the transport system and the further treatment systems occupy even more of the area of the drilling rig. Substantial saving in work area would be realized if the shale shaker and the subsequent solids treatment stage were incorporated into the same work area or footprint of the rig.

The present invention is directed to solving these and other problems which have confronted the art.

### SUMMARY OF THE INVENTION

The present invention provides an integrated, transportable system including a multi-part shale shaker, preferably formed of six screens vibrated by at least one electric vibrator, and preferably four such vibrators. Solids are screend from drilling mud flowing onto the screens, and directed into a trough wherein is located a screw conveyor or augur. A pressure differential is developed across the screens to increase the flow rate of drilling mud through the screens.

The solids are moved by the screw conveyor onto a dryer belt which moves the cuttings beneath a plurality of air nozzles. The air nozzles blow high velocity air over the solids to further remove mud from the cuttings. The cuttings are suitable for discharge directly from the system, and the drilling mud is directed away from the system for further purification and recycling.

These and other features and advantages of this invention will be readily apparent to those skilled in the art.

### BRIEF DESCRIPTION OF THE DRAWINGS

So that the manner in which the above recited features, advantages and objects of the present invention are attained and can be understood in detail, more particular description of the invention, briefly summarized above, may be hand by reference to embodiments thereof which are illustrated in the appended drawings.

FIG. 1 is a side elevation view of the integrated shale shaker and solids dryer of the this invention.

FIG. 2 is an end view of the system of FIG. 1.

FIG. 3 is a top view of the system of FIGS. 1 and 2.

### DETAILED DESCRIPTION OF A PREFERRED EMBODIMENT

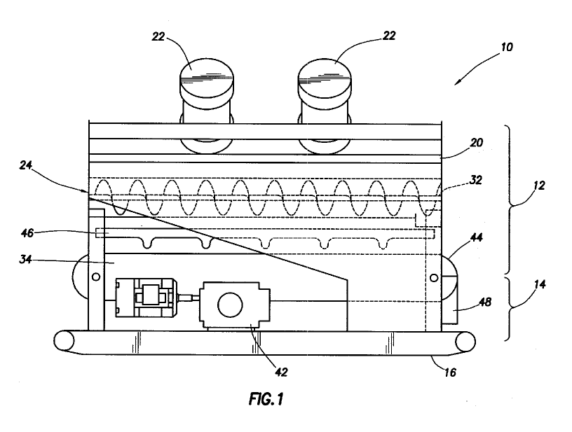

FIGS. 1, 2, and 3 show an integrated system 10 of this invention. The system 10 comprises primarily an upper section 12 defining a new shale shaker and a lower section 14 defining a new cuttings treatment system, all mounted to a pallet or skid 16 for the easy transportation of the entire system 10. The feature of the present invention provides an integrated, portable solids cleaning system.

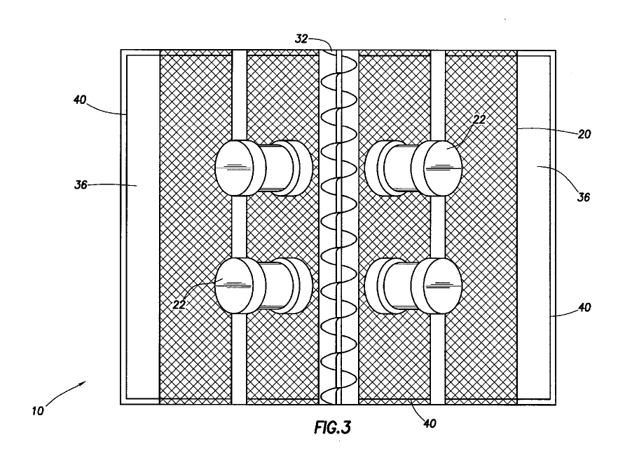

The system includes a plurality of vibrating shaker screens 20, in a preferred embodiment six of such screens. The screens 20 are vibrated by at least one electric vibrator 22, preferably four such vibrators as shown in FIG. 3. The vibratos impart vibratory motion to the screens in a manner well known in the art as drilling mud, carrying cuttings, flows down through the screens. Solids larger than the mesh size of the screens are caught on top of the screens, and the vibratory action moves the solids across the screens down into a center trough 24. Liquid drilling mud, with some smaller sized particles remaining, flows down through the screens and into a reservoir or discharge pan 26. A level of liquid is maintained in the reservoir 26 by a liquid level control device 28 to prevent the reservoir from draining to a level that would allow air to be introduced into the reservoir by way of a liquid discharge pipe 30. Allowing air into the pipe 30 would break the vacuum within the system 10 as described below.

A previously described, the solids from on top of the screens move into the trough 24. An augur or screw conveyor 32 is placed longitudinally within the trough 24 and provides a means for transporting the solids separated by the vibrating screens to a drying device 34. The screw conveyor may be operated in either direction; if operated in a first direction, solids from the shaker screens are directed into the drying device. If the screw conveyor is operated in the reverse direction, then the solids bypass the drying device are simply discharge from the system 10.

Drilling mud to be treated is introduced to the screen(s) either by flowing it directly onto the screen(s) or preferably by flowing it into a container, tank, or possum belly 36 from which it then flow to the screen(s). Alternatively, multiple screens may be staggered and in that case drilling mud from an upper screen onto a lower screen. The possum belly is fed through a mud inlet line 48. Note also that in the preferred embodiment illustrated in the figures that the possum belly introduces the drilling mud from two sides moving the solids toward the centerline of the apparatus. Another feature of the present invention resides in the fact that the drying device is positioned entirely beneath the footprint of the shaker system. As shown in FIG. 3, a set of side walls 40 define the perimeter of the device 10 and the drying device of integrally constructed with the shaker and positioned below the shaker but within the perimeter of the device. Furthermore, the entire device, including the shale shaker and the cuttings drying device is transportable as a unit.

Also positioned below the shale shaker but within the perimeter is an air pump 42. The air pump provides both a negative pressure under the vibrating screens and a dryer belt 44 as well as a positive pressure for a set of air nozzles 46. The air nozzles 46 and their associated distribution system direct high velocity air onto the solids removed by the vibrating screens. Thus, the pump 42 develops a vacuum beneath the screens 20 to draw drilling mud through the screens. This increases the capacity of the system by increasing the flow rate of mud through the screens. The pump 42 also serves to further treat solids moved from the screw conveyor onto the dryer belt.

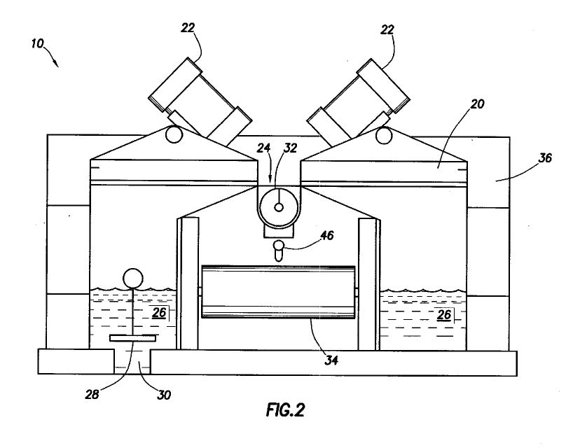

As shown most clearly in FIG. 2, the electric vibrators 22 are positioned at an angle of roughly 45° toward the centerline and the trough 24. That way, the level screens 20 are moved angularly and the solids on top of the screens migrate toward the centerline. In order to accelerate this movement, a time varying pressure differential may be set up, synchronizing the time varying pressure differential with the vibration of the screens. The pressure differential will be less as the screens move in a downward direction in order to help lift the solids off the screens and the pressure differential will be greater as the screens move upward in order to draw more liquid from the solids and to impart greater acceleration to the solids in a horizontal direction toward the trough.

The principles, preferred embodiment, and mode of operation of the present invention have been described in the foregoing specification. This invention is not be be construed as limited to the particular forms disclosed, since these are regarded as illustrative rather than restrictive. Moreover, variations and changes may be made by those skilled in the art without departing from the spirit of the invention.

1. A system for the treatment of drilling mud comprising:
a vibrating screen within a perimeter; and
a cuttings dryer integrally mounted with the vibrating screen and positioned below the vibrating screen within the perimeter.

2. The system of claim 1, further comprising a screw conveyor for moving solids from the vibrating screen to the cuttings dryer.

3. The system of claim 2, wherein the vibrating screen comprises a first set of screens and a second set of screens positioned on either side of the screw conveyor.

4. The system of claim 3, wherein the screw conveyor is reversible, operating in a first direction to direct solids onto the cuttings dryer, and operating in a second direction to bypass the cuttings dryer.

5. The system of claim 1, further comprising an air pump to develop a differential pressure across the vibrating screen.

6. The system of claim 5, wherein the differential pressure varies with time synchronized with the vibration of the screen.

7. The system of claim 5, wherein the air pump is further coupled to an air distribution system to direct air onto solids in the cuttings dryer.

8. The system of claim 1, further comprising a pallet supporting the screen and the cuttings dryer.

9. An integrated shale shaker and dryer for the treatment of drilling mud, comprising:
a plurality of horizontally oriented vibrating screens within a perimeter, the screens oriented on either side of a trough;
a plurality of vibrators coupled to the plurality of screens at an acute angle;
a cuttings dryer integrally mounted with the vibrating screen and positioned below the vibrating screen within the perimeter; and
a pallet supporting the screens, the vibrators, and the cuttings dryer for portable movement of the integrated shale shaker and dryer.

10. The system of claim 9, further comprising a screw conveyor in the trough for moving solids from the vibrating screens to the cuttings dryer.

11. The system of claim 10, wherein the vibrating screens comprise a first set of screens and a second set of screens positioned on either side of the screw conveyor.

12. The system of claim 11, wherein the screw conveyor is reversible, operating in a first direction to direct solids onto the cuttings dryer, and operating in a second direction to bypass the cuttings dryer.

13. The system of claim 9, further comprising an air pump to develop a vacuum beneath the vibrating screens.

14. The system of claim 13, wherein the vacuum varies with time synchronized with the vibration of the screen.

15. The system of claim 14, wherein the air pump is further coupled to an air distribution system to direct air onto solids in the cuttings dryer.
